(19) United States
(12) Patent Application Publication
(10) Pub. No.: US 2026/0127096 A1
(43) Pub. Date: May 7, 2026

(54) DEBUG SYSTEM INCLUDING ABSTRACTION LAYER

(71) Applicant: Renesas Electronics America Inc., Milpitas, CA (US)

(72) Inventors: Rajkumar THIAGARAJAN, San Ramon, CA (US); Mark GOODCHILD, Wargrave (GB)

(73) Assignee: Renesas Electronics America Inc., Milpitas, CA (US)

(21) Appl. No.: 19/348,102

(22) Filed: Oct. 2, 2025

Related U.S. Application Data
(60) Provisional application No. 63/716,957, filed on Nov. 6, 2024.

(51) Int. Cl. G06F 11/362; G06F 3/023; G06F 11/3668

(52) U.S. Cl. CPC G06F 11/3636; G06F 3/0236; G06F 11/3652; G06F 11/3692

(57) ABSTRACT

A debug system is disclosed. The debug system includes a server in communication with a host device, a physical hardware device and a simulation environment. The server is configured to determine a first debug target that includes one of the physical hardware device and the simulation environment, receive a command from the host device that has a first format generated by the host device, convert the first format to a second format that corresponds to the first debug target and transmit the command to the first debug target in the second format. The server is configured to receive a selection of a second debug target that includes the other of the physical hardware device and the simulation environment, convert the first format to a third format that corresponds to the second debug target and transmit the command to the second debug target in the third format.

### CROSS REFERENCE TO RELATED APPLICATION

This application claims the benefit of U.S. Provisional Patent Application No. 63/716,957, entitled “QuickConnect Debug,” filed on November 6, 2024, the entirety of which is incorporated by reference herein.

### BACKGROUND

The present disclosure relates in general to embedded systems. More specifically, the present disclosure relates to a debug system including an abstraction layer for enabling browser-based debugging of embedded systems.

Embedded systems are crucial components in modern devices, playing key roles across various industries such as consumer electronics, automotive, and medical devices. These systems are particularly challenging to test and debug because they interface with numerous hardware components while being subject to strict performance and real-time constraints. Traditionally, debugging embedded systems has relied on specialized tools like In-Circuit Debuggers (ICDs), Joint Test Action Group (JTAG) interfaces, and proprietary Integrated Development Environments (IDEs). Many of these tools often require physical connections to the physical hardware and need specific setups, builds, and vendor-specific software.

As embedded systems grow more complex, there is a need for flexible debugging methods that can support both physical hardware and simulation environments. Simulation environments enable developers to test embedded systems virtually, without requiring physical hardware, but transitioning between these simulation environments and physical hardware often requires separate and distinct workflows, configurations, and tools. This fragmentation complicates the debugging process, increases development time, and introduces potential errors when transitioning from simulated environments to physical hardware.

### SUMMARY

In one embodiment, a debug system is disclosed. The debug system comprises a server in communication with a host device, a physical hardware device and a simulation environment. The server is configured to determine a first debug target that includes one of the physical hardware device and the simulation environment. The server is configured to receive a command from the host device that has a first format generated by a debug interface of the host device, to convert the first format to a second format that corresponds to the first debug target and to transmit the command to the first debug target in the second format. The server is further configured to receive a selection of a second debug target that includes the other of the physical hardware device and the simulation environment, to convert the first format to a third format that corresponds to the second debug target and to transmit the command to the second debug target in the third format.

In one embodiment, a method for implementing an electronic fuse in an integrated protection circuit is disclosed. The method comprises determining a first debug target that includes one of a physical hardware device and a simulation environment, receiving a command from a host device that has a first format generated by a debug interface of the host device, converting the first format to a second format that corresponds to the first debug target and transmitting the command to the first debug target in the second format. The method further includes receiving a selection of a second debug target that includes the other of the physical hardware device and the simulation environment, converting the first format to a third format that corresponds to the second debug target and transmitting the command to the second debug target in the third format.

In one embodiment, an apparatus is disclosed. The apparatus includes a display device, an input device and a user interface configured for presentation on the display device. The user interface includes a web browser that is configured to present a debug interface to a user of the apparatus. The debug interface is configured to determine a first debug target that includes one of a physical hardware device and a simulation environment in communication with a server and transmit a command to the server that has a first format generated by the debug interface. The server is configured to convert the first format to a second format corresponding to the first debug target and transmit the command to the first debug target in the second format. The debug interface is further configured to receive from the user, via the input device, a selection of a second debug target in the debug interface and to transmit the selection of the second debug target to the server. The second debug target includes the other of the physical hardware device and the simulation environment. The server is further configured, based on receipt of the selection, to convert the first format to a third format that corresponds to the second debug target and transmit the command to the second debug target in the third format.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a block diagram illustrating an example debug system according to an embodiment.

FIG. 2 is a flowchart illustrating an example dynamic selection logic process according to an embodiment.

### DETAILED DESCRIPTION

Modern software development is increasingly adopting browser-based tools that are platform-independent and encourage greater collaboration among distributed teams. However, most current embedded system debugging tools still rely on desktop applications or hardware-specific setups, making them less accessible via standard web browsers. A unified solution is needed that integrates embedded system debugging into a browser environment, supporting both physical hardware and simulation models.

The present disclosure introduces a debug system including an abstraction layer that facilitates browser-based debugging for embedded systems, allowing seamless interaction with both physical hardware and simulation environment models. The abstraction layer simplifies debugging by acting as an intermediary between the web browser and the embedded system, providing a standardized and unified interface regardless of the environment. The use of the abstraction layer eliminates the need for specialized tools, streamlines the workflow and offers greater flexibility by enabling developers to debug embedded systems directly within a web browser. The abstraction layer also enhances accessibility, making debugging more portable, collaborative and adaptable across various development scenarios.

By integrating physical hardware and simulation environments into a browser-based debug interface using the abstraction layer, the debug system overcomes the limitations of traditional debugging tools and methods, promoting more efficient and accessible embedded system development.

Some aspects of the debug system will now be described:

### Unified Debugging Interface

The debug system provides a single, consistent interface accessible via a web browser, allowing developers to interact with embedded systems without needing specialized tools. It enables users to perform common debugging tasks, such as setting breakpoints, monitoring variables, stepping through code, interacting with system peripherals and firmware execution tracing.

### Support for Physical Hardware and Simulation Environments

The debug system supports both physical hardware and simulation environments, allowing users to seamlessly switch between the two during the debugging process. The abstraction layer automatically adapts to the embedded system being debugged, translating system-specific interactions into standardized commands at the browser level for seamless debugging in the browser.

### Communication Protocols

The abstraction layer of the debug system translates different hardware-specific protocols into a format that enables communication between the embedded system being debugged and the browser-based debugging tool. This removes the need for direct hardware-specific configurations and reduces complexity.

### Real-Time Debugging and Testing

Users of the debug system can debug and test embedded systems software in real time, regardless of whether they are using a physical hardware device or a simulation environment simulating the physical hardware device or another physical hardware device.

The debug system significantly simplifies the debugging process for embedded systems by providing a browser-based interface that can handle both physical hardware and simulated environments. By abstracting hardware complexities and delivering a standardized debugging experience, the debug system increases flexibility, reduces the barrier to entry and enhances productivity in embedded system software development and testing.

### Dynamic Switching

The debug system enables dynamic switching between physical hardware and simulation environment models without interrupting the debugging session, enabling developers to test different environments without the need to reconfigure their tools.

### Example Debug System

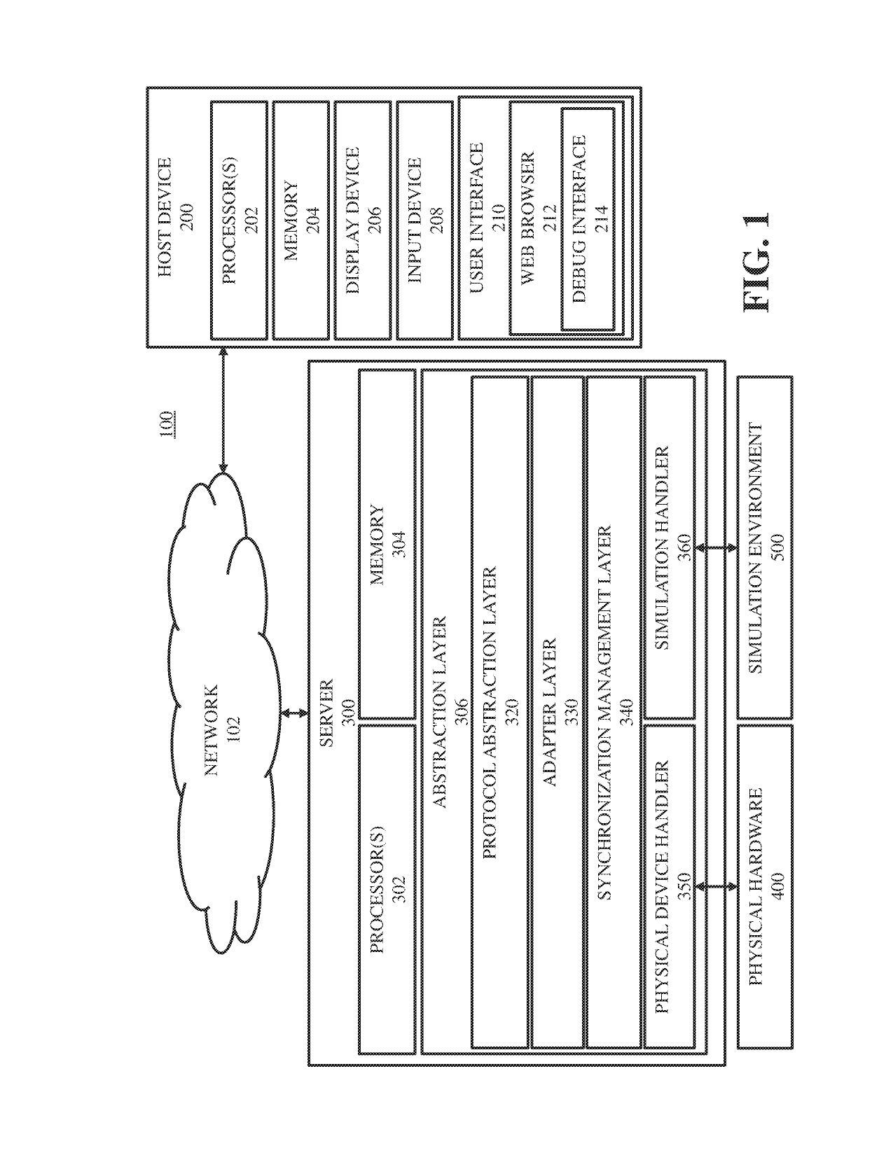

With reference to FIG. 1, an example debug system 100 is described according to an embodiment. Debug system 100 comprises a network 102, a host device 200, a server 300, physical hardware 400 and a simulation environment 500.

Network 102 comprises configured to connect host device 200 with server 300 and comprises one or more wired, wireless or combined wired/wireless networks and corresponding hardware such as hubs, switches, access points, network interfaces or other hardware commonly found in a network. Example wired and wireless networks that may be utilized include the Internet, a wide area network (WAN), a local area network (LAN), satellite, telephone, cable, a fiber-optic, cellular, ethernet, WiFi, WiMAX, Bluetooth®, any other network or connection or any combination thereof.

Host device 200 comprises one or more processors 202, memory 204, a display device 206, an input device 208 and a user interface 210.

Processor(s) 202 comprise, e.g., a processor, a microprocessor, a microcontroller, an application-specific integrated circuit (ASIC), a field-programmable gate array (FPGA), a graphics processing unit (GPU), a printed circuit board (PCB) or any other type of processing circuitry, as well as portions or combinations of such circuitry elements.

Memory 204 comprises, e.g., random access memory (RAM), read-only memory (ROM), flash memory or other types of memory, in any combination. The memory and other memories disclosed herein should be viewed as illustrative examples of what are more generally referred to as “processor-readable storage media” storing executable program code of one or more software programs.

Display device 206 comprises, e.g., a screen, a monitor, a television, phone, smart device, or any other device that is configured to present data or images to a user.

Input device 208 comprises, e.g., a keyboard, mouse, touch screen, or any other physical interface that is configured to receive a user input from a user.

User interface 210 comprises an interactive graphical user interface that may be presented to a user, e.g., via display device 206. The user may interact with user interface 210 using input device 208 to cause an execution of the functionality of server 300 via network 120. For example, in an embodiment, user interface 210 comprises a web browser 212.

Web browser 212, e.g., Chrome, Edge, Safari, Mozilla, a custom web browser or any other web browser, is configured to present a debug interface 214 to a user of host device 200. As an example, web browser 212 may be utilized by the user to log into a website that causes web browser 212 to present debug interface 214 in some embodiments. In other embodiments, debug interface 214 may be part of web browser 212, a plugin to web browser 212 or otherwise be presented in conjunction with web browser 212 in any other manner.

Debug interface 214 comprises a unified interface that enables the user of host device 200 to perform debugging on both physical hardware 400 and in simulation environments 500 that simulate physical hardware using the same interface and commands. Debug interface 214 is configured to support standard debugging operations such as, e.g., setting breakpoints, stepping through code, inspecting memory, controlling peripherals and firmware execution tracing.

Server 300 comprises one or more processors 302, memory 304 and an abstraction layer 306.

Processor(s) 302 comprise, e.g., a processor, a microprocessor, a microcontroller, an application-specific integrated circuit (ASIC), a field-programmable gate array (FPGA), a graphics processing unit (GPU), a printed circuit board (PCB) or any other type of processing circuitry, as well as portions or combinations of such circuitry elements.

Memory 304 comprises, e.g., random access memory (RAM), read-only memory (ROM), flash memory or other types of memory, in any combination. The memory and other memories disclosed herein should be viewed as illustrative examples of what are more generally referred to as “processor-readable storage media” storing executable program code of one or more software programs.

Abstraction layer 306 comprises a protocol abstraction layer 320, an adapter layer 330, a synchronization management layer 340, a physical hardware handler 350 and a simulation handler 360.

Abstraction layer 306 ensures that debug interface 214 can issue the same commands from the web browser 212 regardless of the underlying embedded system being debugged, whether in physical hardware 400 or simulation environment 500. Abstraction layer 306 provides protocol abstraction between debug interface 214 and the target embedded system and is responsible for handling the communication protocols used by the various embedded systems.

Abstraction layer 306 is configured to receive commands from debug interface 214 of web browser 212 in a first format and to translate the received commands into appropriate low-level commands in either a physical hardware-specific format, e.g., a second format, or a simulation-specific format, e.g., a third format, depending on the target embedded system that is currently being debugged. Abstraction layer 306 ensures that the commands from web browser 212 look the same regardless of the underlying hardware (physical or simulated) and enables seamless and dynamic switching between debugging on the underlying physical hardware 400 or simulation environment 500 by translating the same debug command received from debug interface 214 into the corresponding underlying format for its corresponding target embedded system.

Protocol abstraction layer 320 manages the communication protocols used by debug interface 214 and each underlying embedded system that is available for debugging. As an example, for debug interface 214 of host device 200, protocol abstraction layer 320 may be configured to manage communication through, e.g., a TypeScript-based debugging interface, an integrated development environment (IDE) debugging interface, other similar debugging interfaces or any other communication protocol. When a user action in debug interface 214 of host device 200 is triggered, such as, e.g., setting a breakpoint, a command may be sent from debug interface 214 to abstraction layer 306 via a web-based application programming interface (API) such as, e.g., a representational state transfer (REST) API, web sockets or other web-based APIs.

For physical hardware 400, protocol abstraction layer 320 may be configured to manage communication through, e.g., JTAG, Serial Wire Debug (SWD), Universal Serial Bus (USB) or another protocol. For simulation environment 500, protocol abstraction layer 320 may be configured to abstract communication channels such as, e.g., shared memory, TCP/IP sockets or any other communication channel, for interfacing with virtualized hardware devices.

Protocol abstraction layer 320 may comprise one or more configuration files for each available physical hardware 400 and simulation environment 500 that provides correspondences between command formats received from debug interface 214 and corresponding command formats for issuing commands to the underlying physical hardware 400 or simulation environment 500. In some embodiments, these configuration files may be updated as needed based on changes in either physical hardware 400 or simulation environment 500 including, e.g., changes in hardware, software, or any other component of already available physical hardware 400 or simulation environment 500 and the addition of new physical hardware 400 or simulation environments 500 having different command formats.

Adapter layer 330 is configured to determine the target on which a command received from debug interface 214 will be executed, e.g., physical hardware 400 or simulation environment 500, and convert the command into the corresponding debug command for the target, e.g., based on the communication protocol information managed by protocol abstraction layer 320. Adapter layer 330 is configured to forward the translated debug command to the appropriate handler, e.g., physical hardware handler 350 or simulation handler 360, for transmission to the target.

Synchronization management layer 340 ensures that the state of the embedded system (whether physical or simulated) is synchronized with debug interface 214. Synchronization management layer 340 is configured to maintain the state of memory, registers, and peripherals in real-time or near real-time for each target embedded system, e.g., physical hardware 400 or simulation environment 500, ensuring that the user’s actions in debug interface 214 accurately reflect the embedded system's status.

Synchronization management layer 340 also supports dynamic switching between physical hardware 400 and simulation environment 500 without losing system state, enabling fluid and dynamic transitions between debugging on physical hardware 400 and simulation environment 500 during debugging sessions. As an example, in response to receipt of a command to switch the debugging target between physical hardware 400 and simulation environment 500, synchronization management layer 340 may retrieve the state information of the current debugging target, e.g., CPU registers, internal and external memory contents, OS state, debug application and libraries symbol information, core status or any other state information. In some embodiments, the state information that is to be retrieved may be configurable by the user.

The retrieved state information may be applied to the new debugging target. As an example, a connection process may be executed to connect abstraction layer 306 to the new debugging target. Once a program entry point is reached, the new debugging target may be suspended to load the retrieved state information. Depending on the size of the state information, a progress status indicator may be presented to the user in debug interface 214 to show the user the status of the state information being applied. One the state information has been loaded, the new debugging target may be enabled for debugging and the user may continue debugging on the new debugging target.

Synchronization management layer 340 may also determine the available embedded systems that may be selected for use by a user of host device 200. As an example, a user of host device 200 may open web browser 212 and initiate debug interface 214, e.g., by activating a plug-in, entering/logging in to a web address associated with debug interface 214 or in any other manner. Web browser 212 may send a query to server 300 to determine which embedded systems are available for debugging. In some embodiments, web browser 212 may automatically submit the query to server 300 based on an activation of debug interface 214. In some embodiments, the user of debug interface may initiate the query, e.g., by activating a query button within debug interface 214.

Synchronization management layer 340 is configured to detect the available debugging targets, for example, by querying physical hardware handler 350 and simulation handler 360. For example, synchronization management layer 340 may maintain a list of connected physical hardware 400 that are available for debugging. In some embodiments, physical hardware handler 350 may ping its connections to determine what devices are connected as physical hardware 400 and provide this information to synchronization management layer 340 including state and other information. Synchronization management layer 340 may similarly maintain a list of connected simulation environments 500 that are available for debugging and their corresponding states. Synchronization management layer 340 may provide a list of available physical hardware 400 and simulation environments 500 back to debug interface 214 in response to the query.

Physical hardware handler 350 is configured to communicate with the hardware debugging interface of a connected physical hardware 400 to perform debugging commands on the physical hardware 400. As an example, in some embodiments, physical hardware handler 350 may utilize JTAG/SWD or a hardware probe to interface with the embedded device of physical hardware 400.

Simulation handler 360 is configured to communicate with virtual hardware of simulation environment 500 and use APIs provided by the simulation tool to execute the requested debugging commands, e.g., setting a breakpoint in a virtualized ARM Cortex-M CPU. As an example, simulation handler 360 may utilize Renode, QEMU, or another simulator via API calls.

The result of a debugging command, e.g., successful breakpoint set, may be sent back through abstraction layer 306 to the debug interface 214, providing the user of host device 200 with real-time or near real-time feedback within debug interface 214. For example, the result may be provided to physical hardware handler 350 or simulation handler 360, states may be updated by synchronization management layer 340, adapter layer 330 may translate the result format into the format usable by debug interface 214 based on communication protocol information from protocol abstraction layer 320 and abstraction layer 306 may transmit the translated result to debug interface 214.

Physical hardware 400 may include one or more physical hardware devices that are being debugged, which may include, e.g., microcontrollers, microprocessors, system-on-chip (SoC) architectures or other physical hardware components or devices. The physical hardware devices may be directly connected to physical hardware handler 350 or server 300, e.g., using wired connections, probes, or other physical connections, or connected to physical hardware handler 350 or server 300 over a network such as, e.g., network 102, an intranet where server 300 is located, or in any other manner.

Physical hardware handler 350 may be connected multiple different types physical hardware 400, one or more of the same type of physical hardware 400 or in any other manner. As an example, multiples of the same unit, model, etc. of physical hardware 400 may be connected to physical hardware handler 350 such that more than one user, customer, etc., can perform debugging operations on the same type of physical hardware 400 at the same time. In a case where all available units of physical hardware 400 of that type are being utilized, users may alternatively perform debugging on a corresponding simulation environment 500 until the physical hardware 400 becomes available. In some embodiments, debug interface 214 may present a notification to the user that physical hardware 400 corresponding to their simulation environment is now available for debugging.

Simulation environment 500 comprises one or more software-based virtual environments or models of the embedded system, running on a host computer or cloud environment, that replicate the behavior of corresponding physical hardware 410, enabling seamless debugging by a user of host device 200 between simulation environment 500 and physical hardware 400.

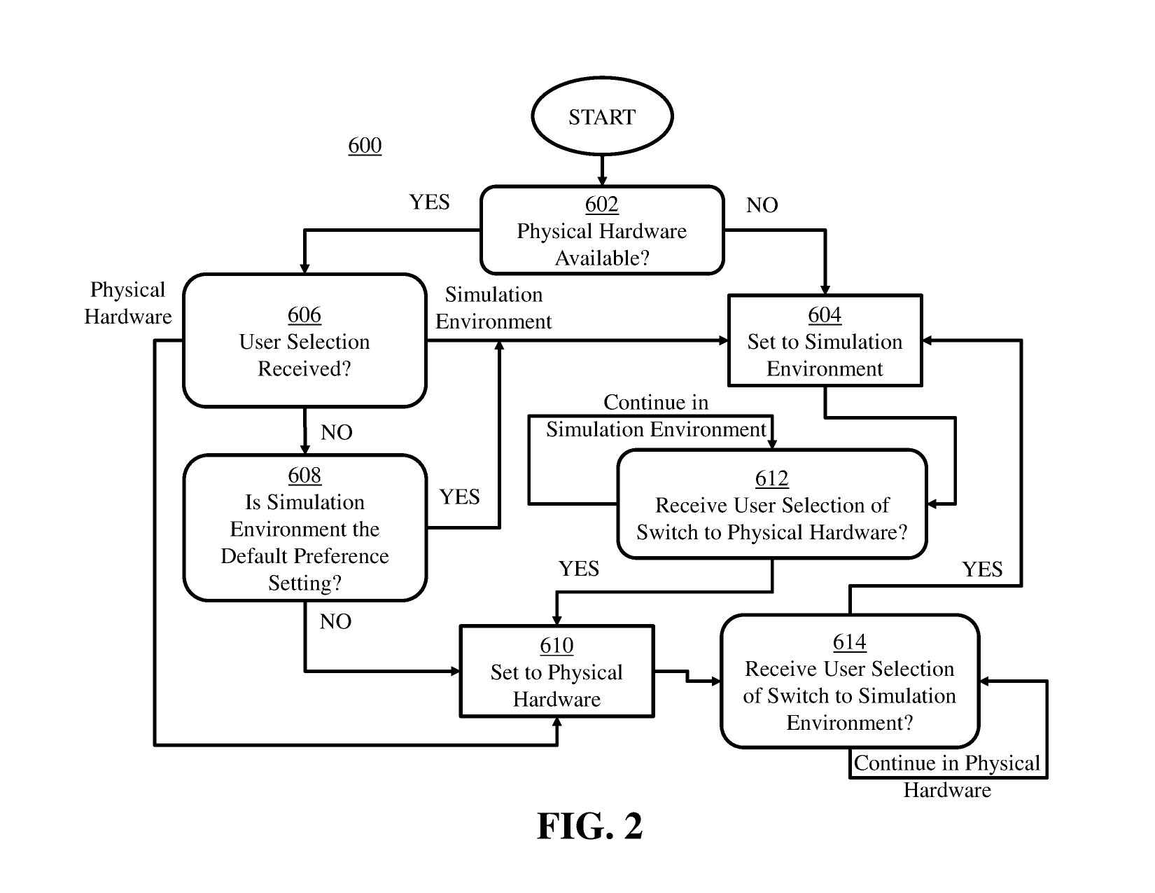

In some embodiments, debug interface 214 may be configured to perform a dynamic selection logic process 600 based on the results of the query to server 300 for available debugging options. FIG. 2 is a diagram of a flowchart of an example dynamic selection logic process 600 in an embodiment. Process 600 may be implemented at least in part by one or more of host device 200, server 300, physical hardware 400, simulation environment 500 or any combination thereof. Process 600 may include one or more operations, actions, or functions as illustrated by one or more of blocks 602, 604, 606, 608, 610, 612 and 614. Although illustrated as discrete blocks, various blocks may be divided into additional blocks, combined into fewer blocks, eliminated, performed in different order, or performed in parallel, depending on the desired implementation. Similarly, additional blocks may be added. The description of FIG. 2 may refer to components shown in FIG. 1.

Process 600 begins at block 602. At block 602, debug interface 214 determines if physical hardware 400 is available, e.g., as a result of a response from server 300 to a query. If physical hardware 400 is not available, the process proceeds to block 604 and debug interface 214 sets the debugging target to simulation environment 500. If physical hardware 400 is available, the process proceeds to block 606.

At block 606, debug interface 214 determines whether or not the user of host device 200 has selected a debugging target, e.g., physical hardware 400 or simulation environment 500, via input device 208. If no selection is received, the process proceeds to block 608. If a user selection of simulation environment 500 as the debugging target has been received, the process proceeds to block 604 and debug interface 214 sets the debugging target to simulation environment 500. If a user selection of physical hardware 400 as the debugging target has been received, the process proceeds to block 610 and debug interface 214 sets the debugging target to physical hardware 400.

At block 608, debug interface 214 determines whether or not simulation environment 500 is set as a default preference. If simulation environment 500 is set as a default preference, the process proceeds to block 604 and debug interface 214 sets simulation environment 500 as the debugging target. If simulation environment 500 is not set as a default preference, physical hardware 400 is set as a default preference or no default preference is set, the process proceeds to block 610 and debug interface 214 sets the debugging tool to use physical hardware 400.

At block 604, after debug interface 214 sets simulation environment 500 as the debugging target, the process proceeds to block 612.

At block 612, debug interface 214 determines whether or not a user selection to switch the debugging target to physical hardware 400 has been received, e.g., via input device 208. If a user selection to switch the debugging target to physical hardware 400 has been received, the process proceeds to block 610 and debug interface 214 sets physical hardware 400 as the debugging target. If a user selection to switch the debugging target to physical hardware 400 has not been received, debugging continues in simulation environment 500. Block 612 may be triggered by the user input, e.g., as an interrupt, poll the user input periodically, or be triggered in any other manner to determine whether the user selection has been received.

At block 610, after debug interface 214 sets the debugging target to physical hardware 400, the process proceeds to block 614.

At block 614, debug interface 214 determines whether or not a user selection to switch the debugging target to simulation environment 500 has been received, e.g., via input device 208. If a user selection to switch the debugging target to simulation environment 500 has been received, the process proceeds to block 604 and debug interface 214 sets simulation environment 500 as the debugging target. If a user selection to switch the debugging target to simulation environment 500 has not been received, debugging continues in physical hardware 400. Block 614 may be triggered by the user input, e.g., as an interrupt, poll the user input periodically, or be triggered in any other manner to determine whether the user selection has been received.

It is important to note that while the user may select to dynamically change the debugging target between physical hardware 400 and simulation environment 500, the debugging commands entered into debug interface 214 by the user to perform debugging actions in either environment may be the same regardless of the particular underlying protocols and commands needed to actually perform debugging in each of the physical hardware 400 and simulation environment 500 due to abstraction layer 306.

In addition, synchronization management layer 340 maintains the state of the debugging target currently being debugged and facilitates a transfer of the state including, e.g., memory contents, register values, peripheral configurations or other state parameters, to the new debugging target. As an example, at any point during a debug session an instruction may be received from the user via debug interface 214 to switch the debugging target, e.g., between physical hardware 400 and simulation environment 500. When such a switch instruction is received, debug execution may be temporarily suspended and a job may be executed by abstraction layer 306 to retrieve the debug state, e.g., using synchronization manager 340. The retrieved state may then be applied to the new debugging target and the debugging session may be resumed. From the user’s perspective, debug interface 214 may appear to be the same and comprise the same functionality and format with only an indication that debugging is being performed on the new debugging target instead of the original debugging target. In this manner the user may seamlessly and dynamically transition the debug session between debugging physical hardware 400 and simulation environment 500.

While process 600 is described with respect to debug interface 214, any other circuitry or component may alternatively perform process 600.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Examples

Example 1: A debug system comprising: a server in communication with a host device, a physical hardware device and a simulation environment, the server being configured to: determine a first debug target, the first debug target comprising one of the physical hardware device and the simulation environment; receive a command from the host device, the command having a first format generated by a debug interface of the host device; convert the first format to a second format, the second format corresponding to the first debug target; transmit the command to the first debug target in the second format; receive a selection of a second debug target, the second debug target comprising the other of the physical hardware device and the simulation environment; convert the first format to a third format, the third format corresponding to the second debug target; and transmit the command to the second debug target in the third format.

Example 2: The debug system of Example 1, wherein the host device comprises a web browser, the web browser being configured to present the debug interface to a user of the host device, the command comprising a web browser-based command.

Example 3: The debug system of any one of Examples 1 to 2, wherein the command comprises one or more of setting a breakpoint, monitoring a variable, stepping through code, firmware execution tracing, interacting with system peripherals and reading memory.

Example 4: The debug system of any one of Examples 1 to 3, wherein the server is further configured to: obtain state information of the first debug target based at least in part on the receipt of the selection of the second debug target; and apply at least a portion of the obtained state information to the second debug target.

Example 5: The debug system of any one of Examples 1 to 4, wherein the server is further configured to maintain communication protocols for a plurality of physical hardware devices including the physical hardware device and a plurality of simulation environments including the simulation environment.

Example 6: The debug system of any one of Examples 1 to 5, wherein the first format, the second format and the third format are different.

Example 7: The debug system of any one of Examples 1 to 6, wherein the server is further configured to: obtain result feedback from the first debug target in the second format; and transmit the result feedback to the host device in the first format.

Example 8: A method comprising: determining a first debug target, the first debug target comprising one of a physical hardware device and a simulation environment; receiving a command from a host device, the command having a first format generated by a debug interface of the host device; converting the first format to a second format, the second format corresponding to the first debug target; transmitting the command to the first debug target in the second format; receiving a selection of a second debug target, the second debug target comprising the other of the physical hardware device and the simulation environment; converting the first format to a third format, the third format corresponding to the second debug target; and transmitting the command to the second debug target in the third format.

Example 9: The method of Example 8, wherein the host device comprises a web browser, the web browser being configured to present the debug interface to a user of the host device, the command comprising a web browser-based command.

Example 10: The method of any one of Examples 8 to 9, wherein the command comprises one or more of setting a breakpoint, monitoring a variable, stepping through code, firmware execution tracing, interacting with system peripherals and reading memory.

Example 11: The method of any one of Examples 8 to 10, wherein the method further comprises: obtaining state information of the first debug target based at least in part on the receipt of the selection of the second debug target; and applying at least a portion of the obtained state information to the second debug target.

Example 12: The method of any one of Examples 8 to 11, wherein the method further comprises maintaining communication protocols for a plurality of physical hardware devices including the physical hardware device and a plurality of simulation environments including the simulation environment.

Example 13: The method of any one of Examples 8 to 12, wherein the first format, the second format and the third format are different.

Example 14: The method of any one of Examples 8 to 13, wherein the method further comprises: obtaining result feedback from the first debug target in the second format; and transmitting the result feedback to the host device in the first format.

Example 15: An apparatus comprising: a display device; an input device; a user interface configured for presentation on the display device, the user interface comprising a web browser, the web browser being configured to present a debug interface to a user of the apparatus, the debug interface being configured to: determine a first debug target, the first debug target comprising one of a physical hardware device and a simulation environment in communication with a server; transmit a command to the server, the command having a first format generated by the debug interface, the server being configured to: convert the first format to a second format corresponding to the first debug target; and transmit the command to the first debug target in the second format; receive from the user, via the input device, a selection of a second debug target in the debug interface; transmit the selection of the second debug target to the server, the second debug target comprising the other of the physical hardware device and the simulation environment, the server being configured, based on receipt of the selection, to: convert the first format to a third format, the third format corresponding to the second debug target; and transmit the command to the second debug target in the third format.

Example 16: The apparatus of Example 15, wherein the command comprises one or more of setting a breakpoint, monitoring a variable, stepping through code, firmware execution tracing, interacting with system peripherals and reading memory.

Example 17: The apparatus of any one of Examples 15 to 16, wherein the server is further configured, based on receipt of the selection, to: obtain state information of the first debug target; and apply at least a portion of the obtained state information to the second debug target.

Example 18: The apparatus of any one of Examples 15 to 17, wherein the server is further configured to maintain communication protocols for a plurality of physical hardware devices including the physical hardware device and a plurality of simulation environments including the simulation environment.

Example 19: The apparatus of any one of Examples 15 to 18, wherein the first format, the second format and the third format are different.

Example 20: The apparatus of any one of Examples 15 to 19, wherein: the server is further configured to obtain result feedback from the first debug target in the second format; and the apparatus is further configured to receive the result feedback from the server in the first format.

The terminology used herein is for the purpose of describing particular embodiments only and is not intended to be limiting of the invention. As used herein, the singular forms "a", "an" and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A debug system comprising:
a server in communication with a host device, a physical hardware device and a simulation environment, the server being configured to:
determine a first debug target, the first debug target comprising one of the physical hardware device and the simulation environment;
receive a command from the host device, the command having a first format generated by a debug interface of the host device;
convert the first format to a second format, the second format corresponding to the first debug target;
transmit the command to the first debug target in the second format;
receive a selection of a second debug target, the second debug target comprising the other of the physical hardware device and the simulation environment;
convert the first format to a third format, the third format corresponding to the second debug target; and
transmit the command to the second debug target in the third format.

2. The debug system of claim 1, wherein the host device comprises a web browser, the web browser being configured to present the debug interface to a user of the host device, the command comprising a web browser-based command.

3. The debug system of claim 1, wherein the command comprises one or more of setting a breakpoint, monitoring a variable, stepping through code, firmware execution tracing, interacting with system peripherals and reading memory.

4. The debug system of claim 1, wherein the server is further configured to:
obtain state information of the first debug target based at least in part on the receipt of the selection of the second debug target; and
apply at least a portion of the obtained state information to the second debug target.

5. The debug system of claim 1, wherein the server is further configured to maintain communication protocols for a plurality of physical hardware devices including the physical hardware device and a plurality of simulation environments including the simulation environment.

6. The debug system of claim 1, wherein the first format, the second format and the third format are different.

7. The debug system of claim 1, wherein the server is further configured to:
obtain result feedback from the first debug target in the second format; and
transmit the result feedback to the host device in the first format.

8. A method comprising:
determining a first debug target, the first debug target comprising one of a physical hardware device and a simulation environment;
receiving a command from a host device, the command having a first format generated by a debug interface of the host device;
converting the first format to a second format, the second format corresponding to the first debug target;
transmitting the command to the first debug target in the second format;
receiving a selection of a second debug target, the second debug target comprising the other of the physical hardware device and the simulation environment;
converting the first format to a third format, the third format corresponding to the second debug target; and
transmitting the command to the second debug target in the third format.

9. The method of claim 8, wherein the host device comprises a web browser, the web browser being configured to present the debug interface to a user of the host device, the command comprising a web browser-based command.

10. The method of claim 8, wherein the command comprises one or more of setting a breakpoint, monitoring a variable, stepping through code, firmware execution tracing, interacting with system peripherals and reading memory.

11. The method of claim 8, wherein the method further comprises:
obtaining state information of the first debug target based at least in part on the receipt of the selection of the second debug target; and
applying at least a portion of the obtained state information to the second debug target.

12. The method of claim 8, wherein the method further comprises maintaining communication protocols for a plurality of physical hardware devices including the physical hardware device and a plurality of simulation environments including the simulation environment.

13. The method of claim 8, wherein the first format, the second format and the third format are different.

14. The method of claim 8, wherein the method further comprises:
obtaining result feedback from the first debug target in the second format; and
transmitting the result feedback to the host device in the first format.

15. An apparatus comprising:
a display device;
an input device;
a user interface configured for presentation on the display device, the user interface comprising a web browser, the web browser being configured to present a debug interface to a user of the apparatus, the debug interface being configured to:
determine a first debug target, the first debug target comprising one of a physical hardware device and a simulation environment in communication with a server;
transmit a command to the server, the command having a first format generated by the debug interface, the server being configured to:
convert the first format to a second format corresponding to the first debug target; and
transmit the command to the first debug target in the second format;
receive from the user, via the input device, a selection of a second debug target in the debug interface;
transmit the selection of the second debug target to the server, the second debug target comprising the other of the physical hardware device and the simulation environment, the server being configured, based on receipt of the selection, to:
convert the first format to a third format, the third format corresponding to the second debug target; and
transmit the command to the second debug target in the third format.

16. The apparatus of claim 15, wherein the command comprises one or more of setting a breakpoint, monitoring a variable, stepping through code, firmware execution tracing, interacting with system peripherals and reading memory.

17. The apparatus of claim 15, wherein the server is further configured, based on receipt of the selection, to:
obtain state information of the first debug target; and
apply at least a portion of the obtained state information to the second debug target.

18. The apparatus of claim 15, wherein the server is further configured to maintain communication protocols for a plurality of physical hardware devices including the physical hardware device and a plurality of simulation environments including the simulation environment.

19. The apparatus of claim 15, wherein the first format, the second format and the third format are different.

20. The apparatus of claim 15, wherein:
the server is further configured to obtain result feedback from the first debug target in the second format; and
the apparatus is further configured to receive the result feedback from the server in the first format.
